(19) United States
(12) Patent Application Publication
(10) Pub. No.: US 2006/0190366 A1
(43) Pub. Date: Aug. 24, 2006

(54) Preview period-end closing

(75) Inventors: Kimberly Ann Nelson, Fargo, ND (US); Brett M. Lindemann, Fargo, ND (US); Donald Dean Nelson, Moorhead, MN (US); Ronald H. Schulz, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/065,009

(22) Filed: Feb. 24, 2005

(51) Int. Cl. G07B 17/00; G07F 19/00

(52) U.S. Cl. 705/30

(57) ABSTRACT

An accounting system is disclosed that provides support for an ability to preview a period-end closing process. When a preview option is activated, the system is configured to provide a view of transactions that would be generated if the period-end closing process were to be carried out. During the preview, the user may choose to continue the period-end closing process or cancel. If the user is satisfied with the preview results, continuing the process will generate actual corresponding closing transactions. If the user is not satisfied with the preview results, canceling the process will return the system to the state it was in before the preview process began.

### BACKGROUND OF THE INVENTION

The present invention generally pertains to software applications that facilitate the tracking of corporate finances. More specifically, the present invention pertains to support for providing an ability to preview a period-end closing process.

Generally speaking, corporate accounting software, including most Enterprise Resource Planning (ERP) software applications, is configured to support conformance with some level of standardized accounting practices. Most solutions include revenue, expense, and/or capital withdrawal accounts in the form of temporary accounts that are reset at the end of an accounting period so that they will have zero balances at the start of the next period. The period of a year is a common length of time for an accounting period. Closing entries are the journal entries used to transfer balances of temporary accounts to permanent accounts. After the closing entries have been made, the temporary account balances will be reflected in a more permanent account such as a retained earnings account.

It is common for the period-end closing process to be relatively automated such that users do not have the ability to see what transactions will be generated until the process is complete. Thus, there is no ability to verify the accuracy of closing entries generated by the period-end closing process prior to committing to and completing the process. Therefore, the user is not afforded an opportunity to make any necessary adjustments prior to the period-end closing process. Adjustments therefore cannot be made prior to seeing the effect of the adjustments on profit.

### SUMMARY OF THE INVENTION

Embodiments of the present invention pertain to an accounting system that provides support for an ability to preview a period-end closing process. When a preview option is activated, the system is configured to provide a view of transactions that would be generated if the period-end closing process were to be carried out. During the preview, the user may choose to continue the period-end closing process or cancel. If the user is satisfied with the preview results, continuing the process will generate actual corresponding closing transactions. If the user is not satisfied with the preview results, canceling the process will return the system to the state it was in before the preview process began.

### BRIEF DESCRIPTION OF THE DRAWINGS

FIG. 1 is a block diagram of a computing environment in which embodiments of the present invention may be implemented.

FIG. 2 is a schematic block diagram of a simplified financial record system.

FIG. 3 is a flow chart diagram illustrating steps associated with a period-end closing preview process.

### DETAILED DESCRIPTION OF THE PREFERRED EMBODIMENTS

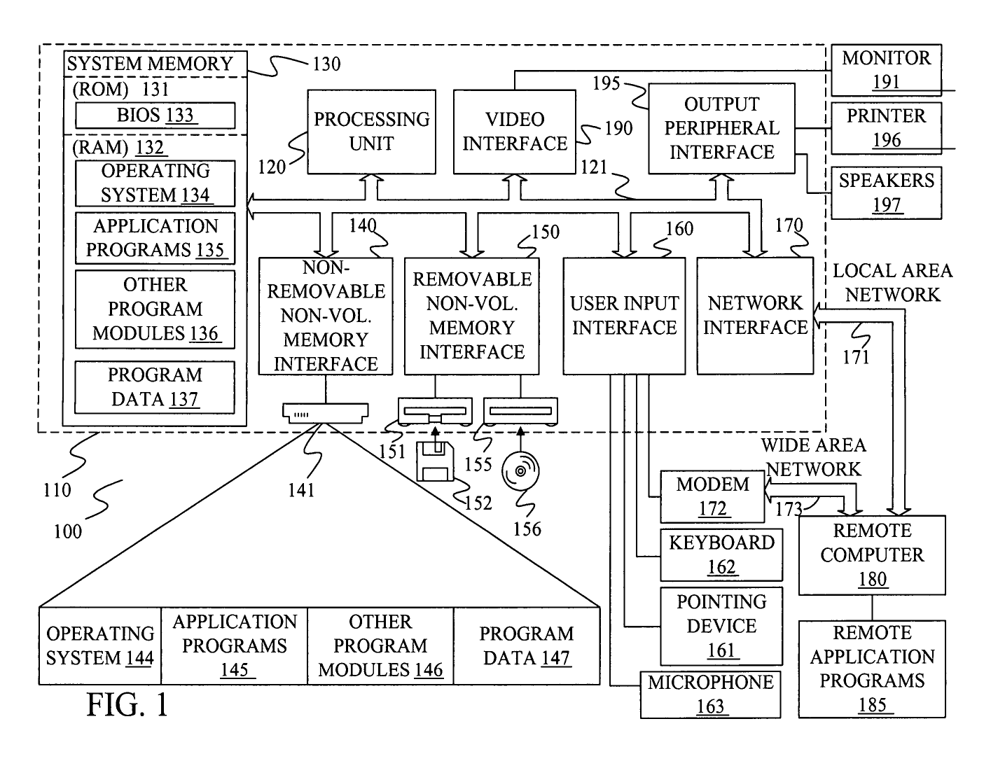

FIG. 1 illustrates an example of a suitable computing system environment 100 in which embodiments of the present invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purposes or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media may be any available media that may be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components may either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

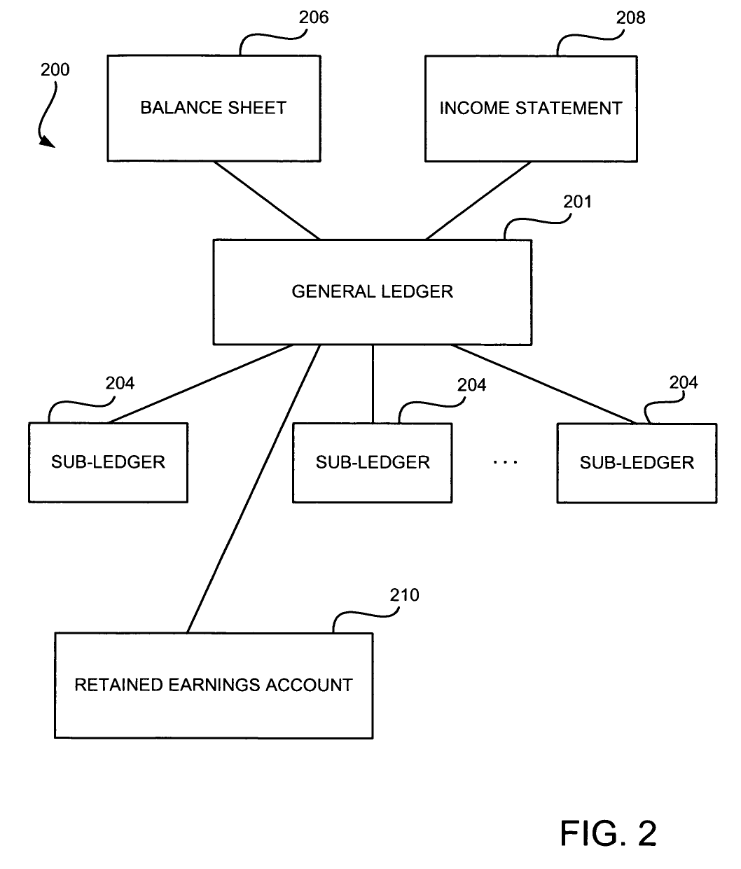

FIG. 2 is a schematic block diagram of a simplified financial record system 200 that represents one context in which embodiments of the present invention may be implemented. The core of system 200 is general ledger 201. All financial transactions flow through general ledger 201 so as to support the creation of a permanent financial history. System 200 also includes a plurality of sub-ledgers 204 that track specific items such as cash, accounts receivable, accounts payable, payroll, inventory and the like. All entries posted to sub-ledgers 204 will transact through general ledger 201. For example, when a customer pays off a bill with cash, the transaction will be posted to the general ledger as well as the two appropriate sub-ledgers 204 (i.e., cash and accounts receivable).

Balance sheet 206 and income statement (sometimes referred to as a “profit and loss” statement) 208 are financial documents that are drawn directly from general ledger 201. More specifically, general ledger 201 will contain the balances that make up line items on reports 206 and 208. Balance sheet 206 is typically configured to provide an overview of financial condition at a given point in time such as at the close of an accounting period. In contrast, income statement 208 provides a profit/loss summary during a predetermined period of time, such as a month, quarter or one-year.

It is common for system 200 to be implemented in the specific context of a software application. It should be noted that, for the purpose of illustrating basic components, system 200 is very simply presented. When actually applied in the context of a real-world business, the structure of such a system may become quite complex, particularly when applied in the context of a large company having a sophisticated enterprise-oriented organization scheme.

It is common for accounting software applications to support conformance with some level of standardized accounting practices. Most applications include reporting functionality in the form of support for balance sheets and/or income statements. In addition, most applications also include revenue, expense, and/or capital withdrawal accounts in the form of temporary accounts that are reset at the end of an accounting period so that they will have zero balances at the start of the next period (commonly one-year). Closing entries are the journal entries used to transfer balances of temporary accounts to permanent accounts. After the closing entries have been made, the temporary account balances will be reflected in a more permanent account such as a retained earnings account. A retained earnings account 210 is indicated in FIG. 2. It should be noted that closing entries are sometimes generated for other purposes as well, such as to transfer balance information for reporting purposes (e.g., transferred to a balance sheet).

For many applications, the period-end closing process is an automated process that does not provide a user with the ability to see what transactions will be generated until the process is complete. In accordance with one aspect of the present invention, a user is provided with an ability to preview transactions that will be generated. The user is then able to verify the accuracy of the transactions prior to committing to completion of the closing process. Through the preview process, the user is given the opportunity to view the closing transactions to determine if any adjustments are necessary. If so, the period end closing process can be canceled and the adjustments can be made prior to actual execution of the period-end closing process, and in one embodiment, after they have seen the affect of the transactions and adjustments on their profit or other financial indicators.

In accordance with one aspect of the present invention, a system is provided with a preview option for previewing the period-end closing process. If the user selects this option, they may illustratively preview period-end closing transactions (e.g., journal entries) as a basis for choosing to continue the period-end closing process or cancel.

In accordance with one embodiment, if the option to preview the period-end closing is turned on, the system will provide a view of closing and balance-brought-forward journal entries that will be generated if the period-end closing process is actually carried out. In one embodiment, preview data is created outside normal transaction data, wherein the preview data may eventually be converted to a normal transaction if the user so desires. For example, as has been described, during the preview process, the user may choose to continue the period-end closing process or cancel. In accordance with embodiment, if the user is satisfied with the preview results, continuing the process will generate closing transactions (e.g., journal entries into the general ledger or related sub-ledgers or reports). In contrast, if the user is not satisfied with the preview results, canceling the process will return the system to the state it was in before the process began. In one embodiment, one transaction or entry is reviewed and acted upon at a time. In another embodiment; however, multiple transactions are simultaneously reviewed and acted upon. Also, without departing from the scope of the present invention, transformation of preview transactions into actual transactions may be step-by-step (e.g., transformed as approved) or collective (e.g., transformed after review process is complete).

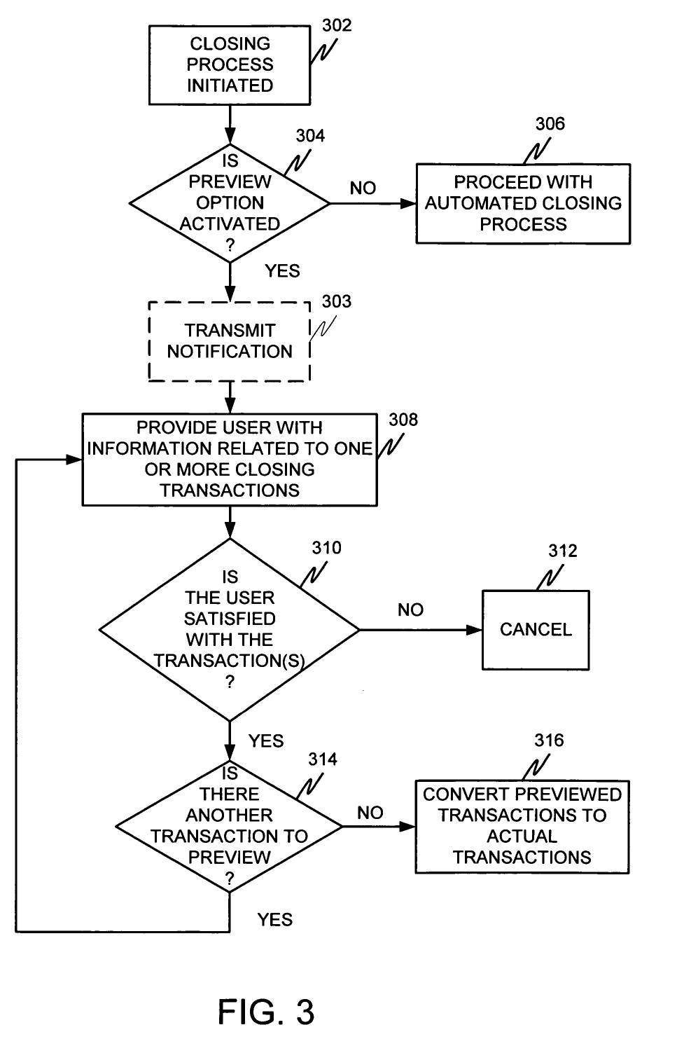

FIG. 3 is a flow chart illustrating steps associated with the preview process in accordance with one aspect of the present invention. The process begins at block 302 where the period-end closing process is initiated. In accordance with block 304, a determination is then made as to whether the preview option is activated. If it is not activated, then the standard automated closing process is carried out in accordance with block 306. If the preview option is activated, in accordance with block 308, a user is provided with information related to one or more potential closing transactions. In accordance with block 310, a determination is then made by the user as to whether the presented transaction(s) is satisfactory. If the user does not give approval, then cancellation occurs in accordance with block 312. In one embodiment, a cancellation results in a return of the system to the state it was in before the process began. If approval is given, in accordance with block 314, a determination is made as to whether there are additional transactions to preview. If there are additional transactions, the process repeats itself. If there are not additional transactions, then preview transactions are converted to actual transactions or entries in accordance with block 316. It should be emphasized that the system could be configured to convert transactions as they are approved or wait until the entire closing process has been reviewed. Both scenarios are within the scope of the present invention.

In accordance with one embodiment, the system is configured with an alert capability that enables a system-facilitated notification to be transmitted to interested parties when a particular point is reached in the preview process. For example, in accordance with optional block 303 in FIG. 3, a notification is provided to inform interested parties when the preview process is going to be carried out. The notification could be, but is not limited to, notification via email, cell phone or pager. The content of the notification illustratively includes an invitation to participate in the review process. In one embodiment, initiation of the notification process is tied to the beginning of the review process. In another embodiment, notification is initiated when a particular point in the review process is reached (e.g., individuals from different departments are notified as records from their departments are encountered or about to be encountered during the review process.

In summary, one aspect of the present invention pertains to a preview component that enables transactions to be previewed while a period-end closing process is being executed. In one embodiment, the general ledger is locked out during the preview process. In one embodiment, once the preview and related period-end closing processes have begun, they must be finished unless canceled. In one embodiment, if the process is not complete, it must be repeated if canceled. In one embodiment, progress through the period-end preview and closing process can be saved such that the user can later pick up where they left off. In one embodiment, a user can start the period-end review and closing process, cancel out, make adjustments, and then start the preview and closing process again.

Although the present invention has been described with reference to preferred embodiments, workers skilled in the art will recognize that changes may be made in form and detail without departing from the spirit and scope of the invention.

What is claimed is:

1. A computer-implemented method for performing a period-end closing process in the context of an accounting system, the method comprising:
providing at least one period-end closing preview transaction;
receiving an input; and
canceling or continuing the period-end closing process depending on whether the input reflects an approval or disapproval of said at least one period-end closing preview transaction.

2. The method of claim 1, wherein providing at least one period-end closing preview transaction comprises providing a preview of at least one balance-brought-forward journal entry.

3. The method of claim 1, wherein providing at least one period-end closing preview transaction comprises providing a preview of at least one closing journal entry.

4. The method of claim 1, wherein providing at least one period-end closing preview transaction comprises providing a collective preview of multiple period-end closing preview transactions.

5. The method of claim 1, wherein canceling the period-end closing process comprises returning the accounting system to the state it was in before the period-end closing process began.

6. The method of claim 1, wherein continuing the period-end closing process comprises converting said at least one period-end closing preview transaction into one or more actual period-end closing transactions.

7. The method of claim 1, wherein continuing the period-end closing process comprises repeating the method but with at least one different period-end closing preview transaction.

8. The method of claim 1 further comprising facilitating a sending of at least one process notification depending on a status of the period-end closing process.

9. The method of claim 8, wherein facilitating a sending comprises facilitating a sending when a particular period-end closing preview transaction is about to be encountered.

10. The method of claim 8, wherein facilitating a sending comprises facilitating a sending when a preview process is initiated.

11. A computer-implemented method for providing a preview of a period-end closing process in the context of an accounting system, the method comprising:
receiving an activation input;
responding to the activation input by activating a preview closing functionality that gives a user an opportunity during the period-end closing process to review a closing transaction prior to finalization of the closing transaction.

12. The method of claim 11 further comprising responding to the activation input by facilitating at least one notification.

13. A computer-readable medium having computer-executable instructions for performing steps that include:
initiating a period-end closing process in the context of an accounting system; and
providing, as part of the period-end closing process, a preview of a closing transaction.

14. The computer-readable medium of claim 13, wherein providing comprises providing a representation of the closing transaction without taking any corresponding steps to execute the transaction.

15. The computer-readable medium of claim 13 further comprising:
receiving an input that represents approval of the closing transaction;
facilitating actual execution of the closing transaction; and
providing a preview of a different closing transaction.

16. The computer-readable medium of claim 15 further comprising:
facilitating actual execution of the different closing transaction; and
providing a preview of another different closing transaction; and
repeating the facilitating and providing steps of claim 16 until the period-end closing process is complete or canceled.

17. The computer-readable medium of claim 16, further comprising:
if the period-end closing process is canceled, then returning the accounting system to the state it was in before the period-end closing process began.

18. The computer-readable medium of claim 13, further comprising facilitating at least one notification based on the status of the period-end closing process.

19. The computer-readable medium of claim 18, wherein facilitating comprises facilitating when the period-end closing process is initiated.

20. The computer-readable medium of claim 18, wherein facilitating comprises facilitating when the period-end closing process reaches a predetermined point in the process.
